(19) United States
(12) Patent Application Publication
(10) Pub. No.: US 2007/0190503 A1
(43) Pub. Date: Aug. 16, 2007

(54) Method of mind mapping utilizing meta-cognitive learning

(76) Inventors: A. Pontish Z. Yeramyan, Newton Square, PA (US); Pen-Pen Chen, Kendall Park, NJ (US); Arsine Oshagan, Radnor, PA (US); Amy L. Sexton, Media, PA (US); Sarah Drewniak, Media, PA (US); Daniel G. Speirs, Rosemont, PA (US)

Correspondence Address: Robert B. Famiglio, Esquire;Famiglio & Associates, P.O. Box 1999, Media, PA, 19063, US

(21) Appl. No.: 10/948,054

(22) Filed: Sep. 22, 2004

Related U.S. Application Data
(60) Provisional application No. 60/504,848, filed on Sep. 22, 2003.

(51) Int. Cl. G09B 19/00

(52) U.S. Cl. 434/156

(57) ABSTRACT

A method for learning in which individuals utilize a specific process to recognize both the content and the structure of their thinking. The method provides a means for infinite and recursive expansion within an individuals thinking and learning process. The depth and clarity of identification of the thinking provided by the method creates an explicit type of comprehension, which expands an individual's efficiency, competency, and capacity to learn from another. The preferred embodiment utilizes a method which builds upon an assumption that human cognition in any individual is the result of a closed network of connections, assembled from past experience. The results or output of the system disclosed is meaning expressed in language. The system allows for examination of thinking in terms of language wherein the meaning of the language is essentially decoded to discern how meaning is codified by an individual at a particular moment in time.

### REFERENCE TO PRIOR APPLICATIONS

This application claims the benefit of the applicant's U.S. provisional patent application No. 60/504,848 filed Sep. 22, 2003.

### BACKGROUND OF THE INVENTION

1. Field of the Invention

The present invention relates to methods for learning in human subjects. Generally, the present invention relates to a process utilizing both cognitive and linguistic theories that promotes the rapid development of meta-cognition by training individuals to participate in a structured examination of their thinking in relation to a desired outcome. More particularly, it is a method and associated apparatus for acknowledging outcomes in order to identify the content and form of the thinking that resulted in said outcomes.

2. Background and Prior Art

There is a need for a reliable, comprehensive, and generalizable means of expanding individuals'comprehension and learning capabilities. Means to assess the status and changes in status of understanding will have a direct impact on individuals'ability to generate, evaluate and act upon new thinking. Furthermore, employers, schools, and many other kinds of organizations, which currently rely on less precise methods for training and instruction, will be able to increase success, decrease failure, and maximize their effectiveness via more suitable placement, more targeted development efforts, and a more thorough excavation and utilization of the existing intellectual resources. For the individual, pursuit of any desired outcome inevitably involves the need to assure being capable to undertake the necessary vocational, social, and/or personal responsibilities. In that it provides precise information on an individual's status on the path to necessary knowledge (and hence, the desired outcome), the present invention is a reliable means of charting the progressive development of a particular individual's learning.

By tracking the development of an individual's thinking, rather than the status of an individual's deviation from normative behavior or the quantitative level of aptitude with respect to a particular learned skill, the present invention greatly expands the potential for predicting success regardless of the context of application. Furthermore, by teaching individuals to self-generate and self-direct their own learning, the present invention creates the potential for infinitely sustainable growth and development on an unprecedented level.

The rise and fall of individuals, organizations, and entire civilizations has consistently been ascribed to changes in the relative correspondence between requisite and available intellectual resources. Viewed from this perspective, human capabilities—intellectual capital, rather than the possession of physical assets—are projected to be the basis of future power and wealth. The present invention is thus immensely valuable in its ability to reliably examine and support the expansion of existing knowledge.

The use of various types of learning techniques and methods are known in the prior art. Learning that relies on cognitive or linguistic methods generally involves discussion of the psychological and linguistic theories that underlie the method and specific training, incorporating these discussions into the precise steps necessary to employ the method itself. These learning systems employ a variety of specific steps to cause a desired change in an individual's ability to acquire the specific information of the knowledge set in question.

There is a body of literature which generally relates to the present invention. However, none of the prior art specifically teaches or describes the method according to the invention. While the prior art dealing with learning methods to alter an individual's ability to acquire specific information from a particular knowledge set are useful for their intended purposes, the prior art does not address the convergence of cognitive and linguistic theory that underlie the present invention. Similarly, the learning method described in the preferred embodiment disclosed is completely different from descriptions of methods found in prior art.

3. Objects of the Present Invention

The invention addresses the aforementioned inadequacies in available learning methodologies—limited reliability and practical utility, restricted generative capacity, imprecision, minimal management/maximization of existing resources, focus on generalized versus individualized data, limited predictive value, reliance on external supervision resulting in limited sustainability of growth. Accordingly, it is the object of the present invention:

1. to distinguish the content and form of any individual's current thinking regardless of context, including and especially as related to any role in any group, organization, or culture, or for any job, responsibility, or pursuit of any desired outcome.

2. to assess the status of an individual's current state of thinking/learning with respect to the capability to achieve any desired outcome/fulfill any specific role.

3. to track the changes in individuals'thinking/learning as a result of their intentional attempts to develop/expand said thinking/learning.

4. to facilitate the use of meta-cognitive learning methods in order to achieve faster, more effective attainment of desired capabilities by all individuals, groups, and organizations, in particular, in workplace and educational settings.

5. to significantly increase accuracy in predicting the appropriateness of an individual's capabilities to perform successfully in any specific role and situation (via more encompassing, sensitive and discriminating matching of individuals'thinking/learning attainment status with capability requirements.)

6. to teach individuals to self-select the optimum additional thinking/learning to effect a specific change in their capabilities necessary to produce a desired outcome or fulfill a specific role.

7. to identify alternative thinking/learning in achieving specific successes and alternative paths to the attainment of desired outcomes, thereby maximizing the existing intellectual resources without wastefully or unfairly overlooking unusual abilities or unorthodox paradigms.

8. to teach individuals to provide themselves and others with just-right-challenges (learning/growth opportunities that are both relevant and suitably challenging in that they generate new thinking/create new possibilities for application).

9. to teach individuals to make their cognitive assets available to others (to teach others) by distinguishing the content and form of their current thinking as related to a specific role or outcome.

10. to evaluate the capabilities of individuals who are teaching/mentoring/training others in order to more effectively and accurately match them with those in need of their particular abilities (A synergistic benefit is anticipated from applying the processes, systems and apparatuses of this invention to both “trainers” and “recipients of training.” The thinking honed by providers using the invention in developing their own capabilities will not only result in more skilled training for recipients, but will also provide opportunities for developing, improving and expanding upon their own learning.)

11. to teach individuals to self-select roles and situations that oblige them to expand their present thinking/learning/capabilities, therein creating a self-perpetuating context for their own learning, growth and development.

12. to efficiently and effectively manage the available human resources, particularly as related to the transfer of knowledge/thinking from individuals with particular capabilities to other individuals in need of such, or further developed, learning.

13. to teach individuals to identify discrepancies between their actual thinking/learning and the thinking/learning necessary to achieve a desired outcome, and to automatically engage in expansion/adjustment of their thinking (learning) with the purpose of achieving a specific desired outcome (while also improving the proficiency of objects numbers 1 and 4 above).

14. to carry out ongoing and longitudinal analyses of the data on individuals using the invention so as to identify potential improvements and adjustments indicated thereby to improve the performance of this invention in all applications.

15. to establish a database of thinking systems (content and structure) which, through the expert systems functions of this invention, will result in the identification and dissemination of said information, enabling more individuals, groups and organizations to achieve more success in all roles and situations worldwide.

16. to facilitate the further attainment and maintenance of human cognitive abilities and intellectual assets by all individuals, groups, organizations, and cultures.

17. to facilitate greater, more effective, more efficient development of essential learning, especially those types of thinking/learning minimally previously addressed because of inadequacies in available methodologies (resulting in more effective individuals, groups and organizations and, consequently, the greater attainment of specific goals and overall human achievement.)

### SUMMARY OF THE INVENTION

The present invention provides a method, namely a meta-cognitive learning method for training individuals in the steps of a specific process designed to promote the use of more late-evolving, advanced portions of the human brain, so as to facilitate higher-level thinking (higher cortical functions), popularly termed meta-cognition—meaning the ability to think about thinking. The method teaches individuals how to distinguish the content and structure of their own thinking, and to use that knowledge to expand their system—that is, as the basis for further learning.

Learning may take place via extension and application within an individual's own system of thinking, or via the intentional addition of new thinking acquired and/or adapted from an outside source. In either case, the method teaches individuals how to efficiently generate for themselves learning that is effective and recursively expandable, resulting in maximal use of available intellectual resources and a significantly greater potential for consistently producing desired outcomes.

The process, which teaches individuals to meta-cognate, comprises the steps of: having individuals distinguish their outcomes associated with a particular subject; having individuals select a theme or specific outcome from that list and examine their thinking (relevant knowledge) via language; creating a visual model/schema of their thinking as expressed in their language; teaching the individual to study their thinking in order to generate new thinking (learning) via expansion of or addition to the present system; engage the individual in learning via application of their current language (thinking system) to new/additional content; and/or engage the individual in learning via the acquisition of new thinking via the language of an outside source; and/or engage the individual in facilitating the learning of another by sharing the source code of their learning as represented in their language (thinking) system (likely advancing their own learning in the process).

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable arts. If any other meaning is intended, the specification will specifically state that a special meaning is being applied to a word or phrase. As used in this disclosure, the word “maxiom” shall mean generalized rules about oneself, others, the world, etc.

### BRIEF DESCRIPTION OF THE DRAWINGS

FIG. 1 is a graph depicting the relationship between the basic elements that interact (the inquiry questions, the thinking strands, conscious and sub-conscious cognition) in the meta-cognitive learning process.

FIG. 2 is an illustration portraying the manner in which any framework of thinking (“maxiom set”) achieves a particular outcome as a result of both thinking that facilitates the outcome (“cooperating maxiom strands”) and thinking that obstructs the achievement of the outcome (“counter maxiom strands”).

FIG. 3a is a diagram of the overall process of the invention for teaching individuals to meta-cognate in order to expand their comprehension and learning capabilities.

FIG. 3b is a companion diagram of FIG. 3a which details the mid-section of 3a (the part of the process occurring between distinguishing “outcomes” and distinguishing the “core conceptualization”) by showing the recursive process through which maxioms (of either set) are distinguished.

FIG. 4 is a flow chart showing the steps in the Internal Learning Process.

FIG. 5 is a flow chart showing the steps in the External Learning Process.

FIG. 6 is a standardized map representing an archetypal maxiom set in relation to a particular core conceptualization and a specific outcome.

FIG. 7a through FIG. 7b is a listing of the full protocol for implementing a preferred embodiment of the meta-cognitive learning method.

### DETAILED DESCRIPTION OF THE PREFERRED EMBODIMENT

The present invention is a method for training individuals in a learning methodology that utilizes specific processes to facilitate meta-cognition/higher cortical function by having the individual focus on and distinguish both the content and structure of their thinking in relation to a specific outcome or context. Although specific embodiments of the present invention will now be described with reference to the drawings, it should be understood that such embodiments are by way of example only and merely illustrative of but a small number of the many possible specific embodiments which can represent applications of the present invention.

In the following description all references to role and situation are intended to include all undertakings of an individual including at work and play, in a community and culture, as service provider and recipient, as student and teacher, as mentor and apprentice, as coach and trainee and as a participant in any and all other social and learning activities in any and all specific settings including particular workplaces, schools, communities and public facilities.

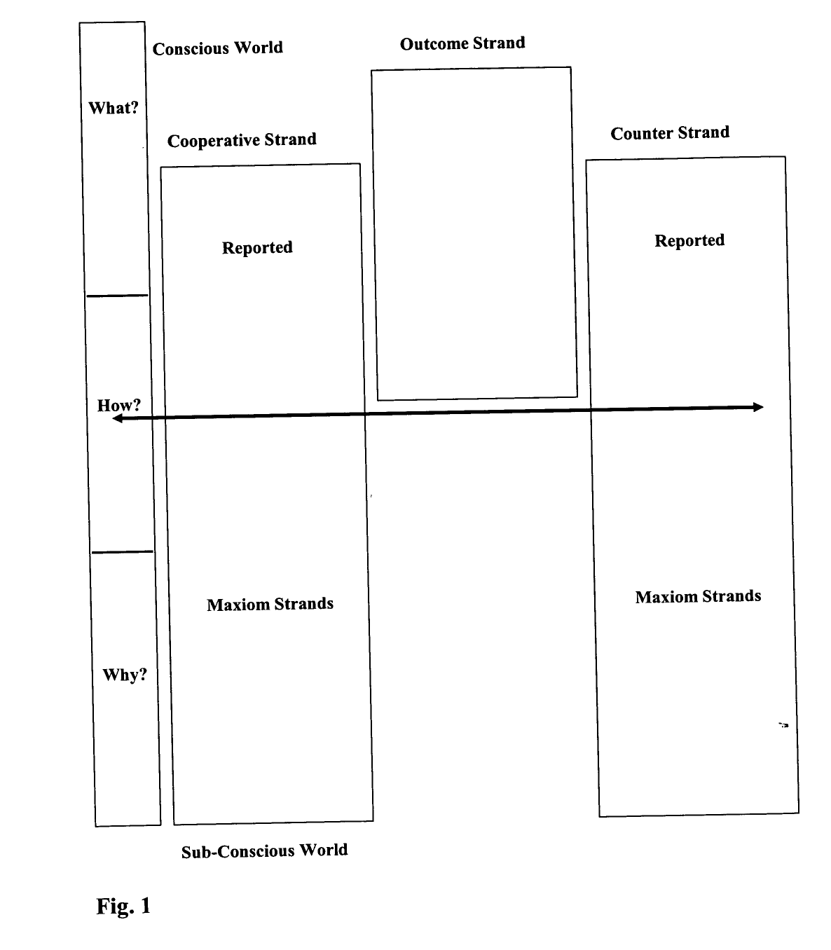

The method according to the present invention relies upon cognitive psychological and functional linguistic theories. Specifically, the present invention is built upon the theory that human cognition (thinking) in any individual is the result of a closed network of connections, assembled from past experience. FIG. 1 is a graphical depiction of the relationship between the basic elements that interact in the meta-cognitive learning process. Those basic elements include the inquiry questions, the thinking strands, conscious and sub-conscious cognition. This graphical depiction of the of basic elements will be familiar to those skilled in the art.

Meaning is an outcome of the structure of the system, and is expressed in language. By examining the thinking via language, it is possible to discern not only the meaning, but how that meaning is codified by an individual at a particular moment in time. This meta-knowledge (knowledge about knowledge) results in the ability to expand the application of a given segment of thinking, or to modify a given segment of thinking at will. Once said thinking is distinguished, the significance of the system is labeled and examined for the purpose of expanding the utility of the thinking. This expansion (learning) is accomplished by applying the thinking to new areas, by imparting the thinking to others in a usable manner, or by modifying the thinking via input to achieve a desired outcome.

Thinking about one's thinking (meta-cognating) involves the intentional activation of the more recently-evolved areas of the human brain—specifically, the frontal lobes. Thought to have developed some 50,000 to 150,000 years ago, this area of the brain controls the creation of ideas and the formation of plans, objectivity, logic, analysis, self-awareness, the transformation of emotional reactions to subjective feelings—essentially, all “higher mental functions.” The cognitive processes which take place in this part of the brain are swiftly executed in a largely automatic, sub-conscious manner. The output—our assessments, judgments, opinions, understandings, etc. are what we are most aware of. That which generated the outputs—the thinking beneath the thinking—remains largely unexamined in our day-to-day cognition and resulting activities. On the whole, this lack of awareness serves a highly practical, functional purpose. Current theories of neuroscience explain the human brain as a massive network of neurons that interact with one another via electronic activations/impulses. As man evolved, becoming increasingly skilled in the complex cognitive functions that were necessary to support more complex societal and technological circumstances, the ability to execute (especially higher-level) cognitive activities with velocity became increasingly advantageous. The cost of this automaticity, however, is a lack of insight into the very components and/or workings of the system itself. The restricted monitoring of our own processing results in both an efficient to effortless day to day existence, and in a lack of flexibility in mental functioning. Without intentionally generating it, we have but limited access to our own thinking.

As with earlier advancements that resulted in the development of the frontal lobe (giving humans cognition, consciousness), the present human condition necessitates a breakthrough in cognitive function. Expanding the ability to meta-cognate represents a forward-leap in human cognitive capability. The implications of such a development are massive and far-reaching, and are most easily described/expressed in terms of their potential for human learning. Furthermore, to the extent that it is our thinking that guides our behavior, the ability to influence, much less to generate on a far broader and more sustainable scale, the specific outcomes desired in any given situation or circumstance (by intentionally creating the thinking that will support the necessary actions) is greatly expanded. By mastering the next level of learning—thinking about thinking and then using that knowledge to generate new thinking—humanity will experience new levels of freedom and development.

The specific training and method of the present invention teaches individuals to specifically utilize the skill of meta-cognition to facilitate their own learning. By distinguishing both the content and the form of their thinking as captured in their language, individuals gain skills that will allow them to infinitely and recursively expand their own knowledge, thereby having a direct impact on their ability to generate new/desired outcomes.

In a preferred embodiment, individuals participate in several complete rounds of training during which they apply the method to their own learning. In addition, the individuals will receive visual models (schemas) of their thinking created real-time during their sessions. These visuals will reify their thinking, will support further learning, and will reinforce the method.

The method according to the present invention utilizes a specific process that facilitates learning by focusing on and emphasizing distinguishing the content and form of the thinking associated with a particular subject as expressed in language. The method of the present invention teaches individuals to meta-cognate through the steps of: having an individual distinguish his or her outcomes associated with a particular subject; having said individual select a theme or specific outcome from that list and examine his or her thinking in terms of relevant knowledge via language; creating a visual model or schema of his or her thinking as expressed in the subjects own language; teaching the individual to study his or her thinking in order to generate new thinking or learning via expansion of or addition to the present system; engage the individual in learning via application of his or her current language or thinking system to new or additional content; and/or engage the individual in learning via the acquisition of new thinking via the language of an outside source; and/or engage the individual in facilitating the learning of another by sharing the source code of their learning as represented in their language or thinking system. This process also facilitates likely advancing the presenter's own learning in the process of carrying out the method for the learning of others.

According to the method of the present invention, individuals are instructed to make an extensive written list of the specific outcomes associated with a particular subject, context, or circumstance. Using their own judgment as to what to include, they are directed to create this list and then to study their outcomes, focusing on any trends that are indicated, or on any specific outcomes that stand out to them.

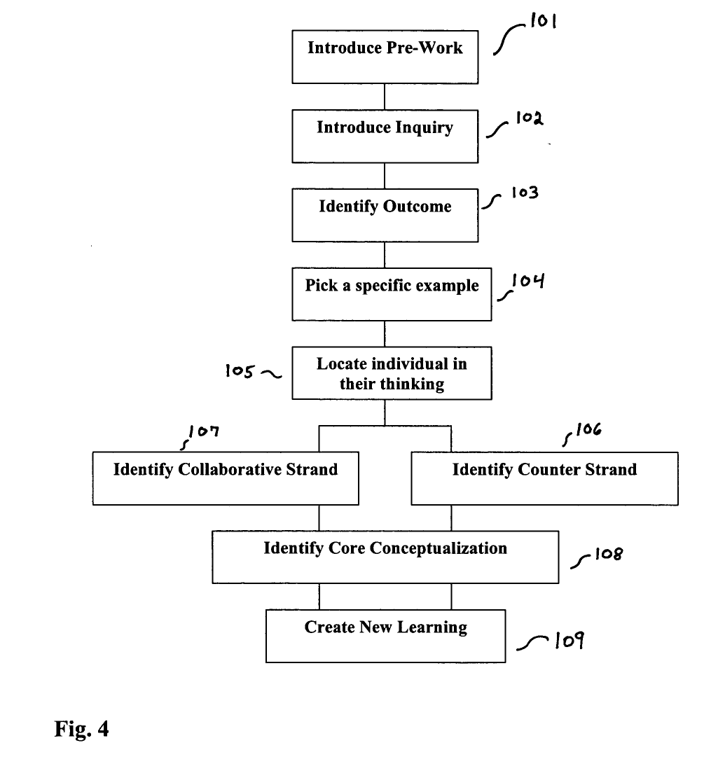

The individuals are taught to engage in an inquiry process by examining their thinking (via their language) associated with a specific outcome or a trend that they have selected. This is illustrated in FIG. 4. As can be seen in FIG. 4, first there is an introduction of prework 101. Then the inquiry is introduced 102. The outcome is identified 103 and a specific example is thereafter shown at 104. The process then continues to assist the individual to locate themselves in their thinking 105. The method then provides that one would identify a counter strand 106, and identify a collaborative strand 107. Flowing from each of the above, one then identifies core conceptualization 108. Through the process shown in FIG. 4, the method assists in creating new learning 109.

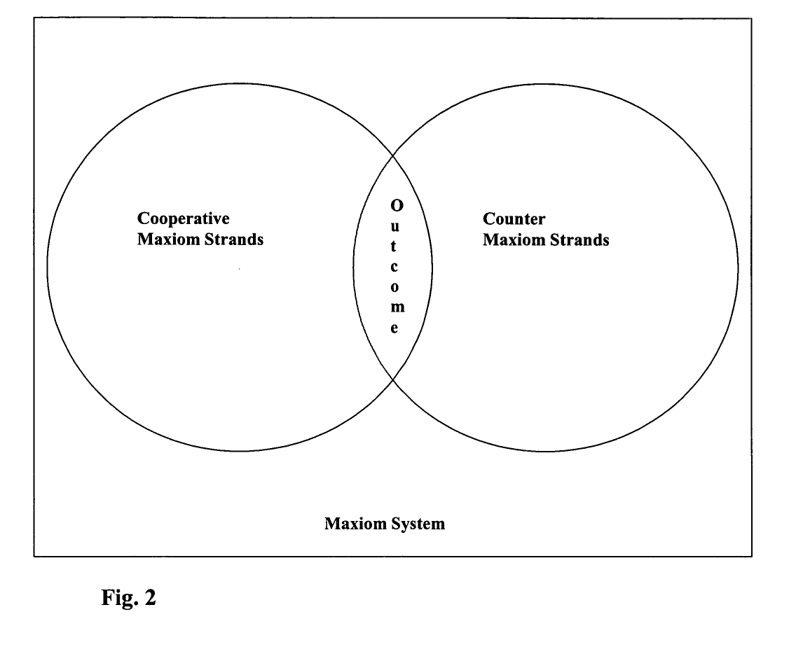

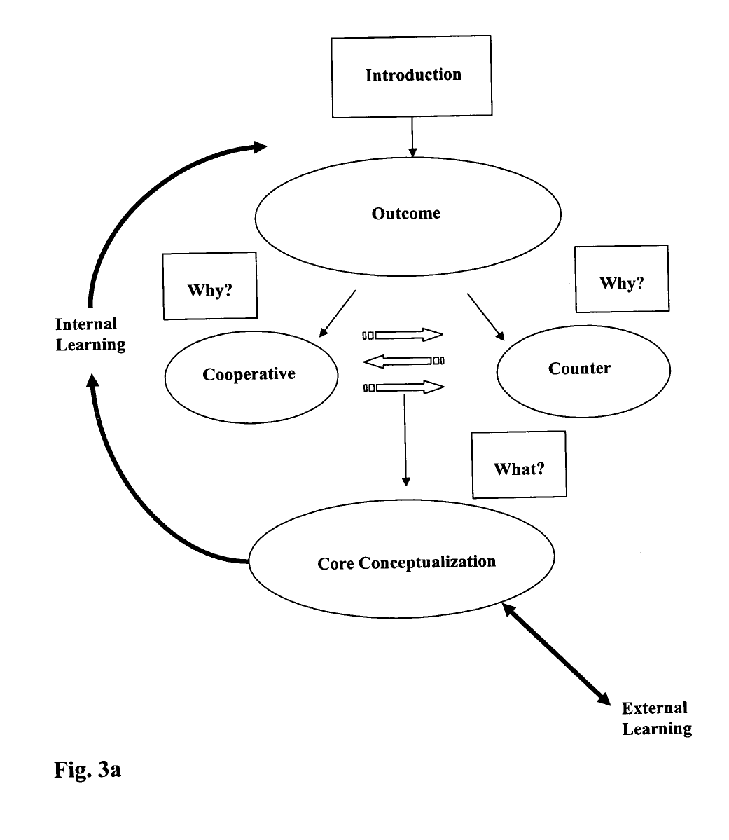

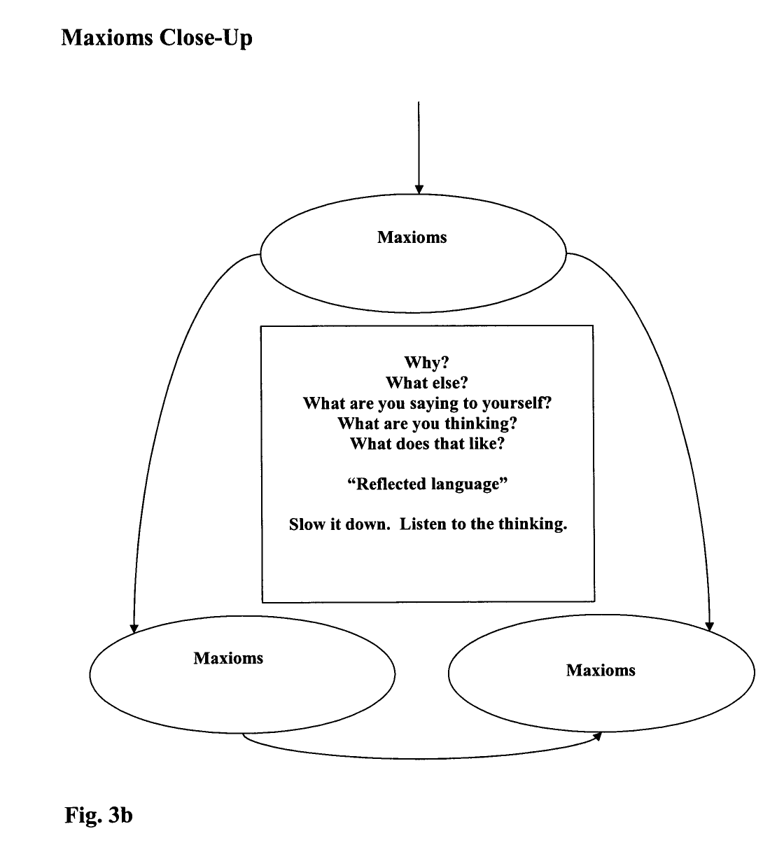

Turning now to FIG. 2, FIG. 3a and FIG. 3b, the graphical presentations illustrate how individuals are trained to employ a recursive process to elucidate the thinking that supported the generation of the outcome (cooperative maxiom strands), as well as the thinking that countered or challenged the specific result or trend (counter maxiom strands). Their language is recorded real-time, and the individual is asked to label or specify a designation of the aggregate (core conceptualization) of their thinking.

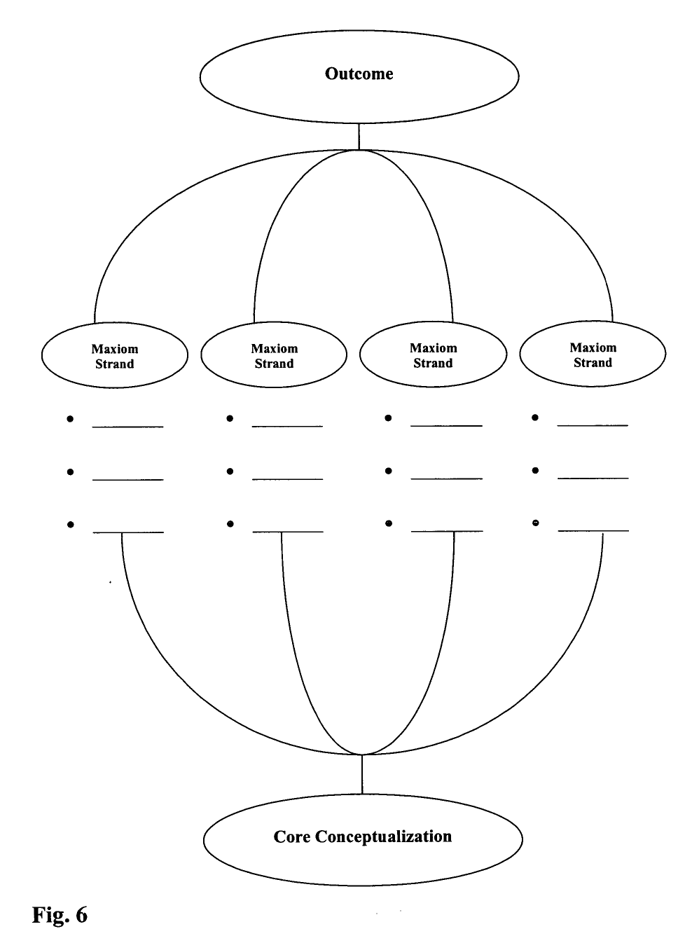

The individuals are taught to create a visual model or schema of their thinking as expressed in their language. Individuals are trained to recognize thematic elements in their speaking, along with the sub-components composing each element. Individuals are taught to diagram the relationships between the elements, and to appreciate the mutability and pervasiveness of the thinking. This diagraming process is illustrated in FIG. 6.

Using the visual model as a guide, individuals are trained to study the thinking in the context of a specific desired outcome. Individuals are taught to generate learning by selecting between three options: expanding the current thinking to the new/desired outcome; sharing the source code of the thinking with another in order to facilitate their learning as a means of generating the new/desired outcome; acquiring new thinking from an outside source by determining the source code of that individual's thinking and internalizing the language, thereby expanding the thinking supporting the achievement of the new/desired outcome.

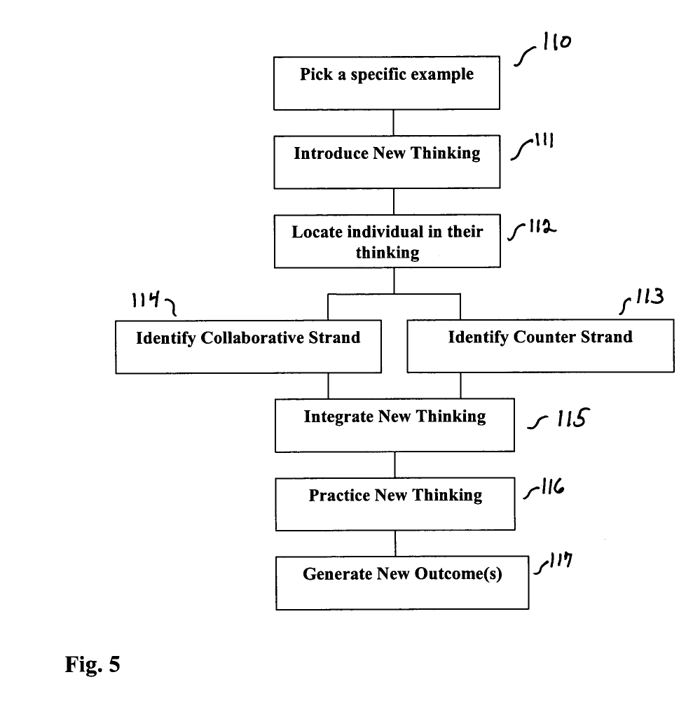

In order to generate any of the three modes of learning, individuals are trained to focus on their own thinking, working from the specific context of the outcome they intend to produce. Individuals study the present thinking in order to pinpoint those elements of the linguistic source code that will be extended, applied, or supplemented in order to achieve the desired outcome. Turning now to FIG. 5, it is demonstrated therein how the newly generated language/thinking/learning is then repeatedly articulated in order to solidify the activation of the learning process. (This process continues through application via action, and is infinitely recursive in form.) First, a specific example is picked 110. New thinking for the subject is then introduced 111. In continuing with the process, the individual is located in their thinking 112. At such point the process identifies a counterstrand 113 and/or a collaborative strand 114 to develop. After identifying either a collaborative strand and/or a counterstrand, the process assists in integration of new thinking 115. The process is reinforced by practicing new thinking 116 being developed by the system. Through the process shown in FIG. 5, a new outcome is generated 117.

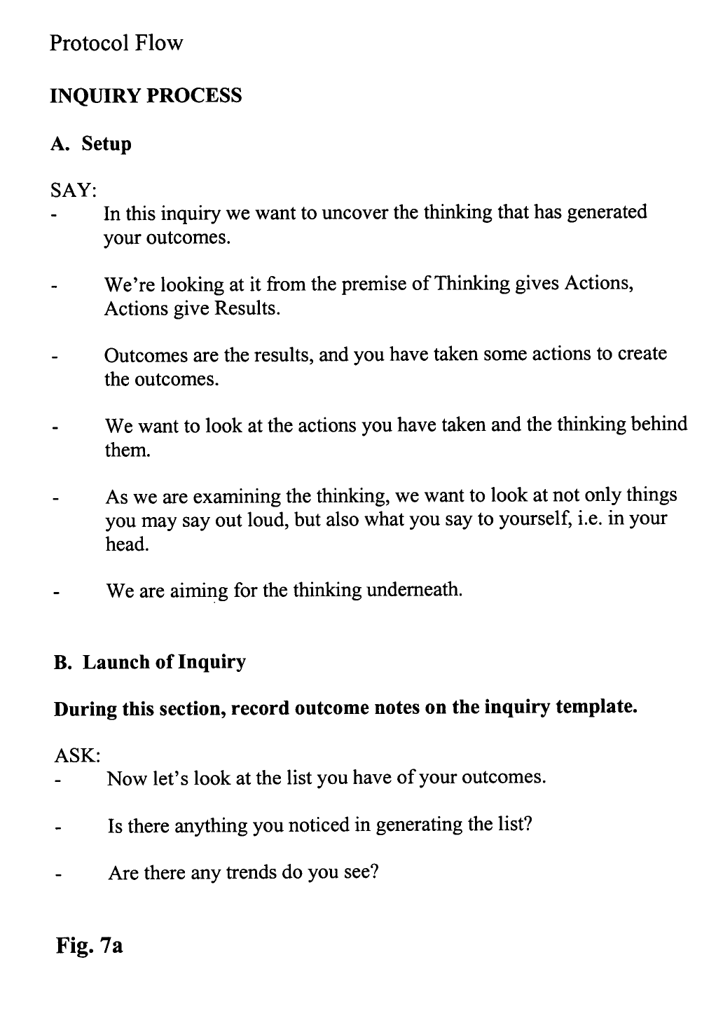

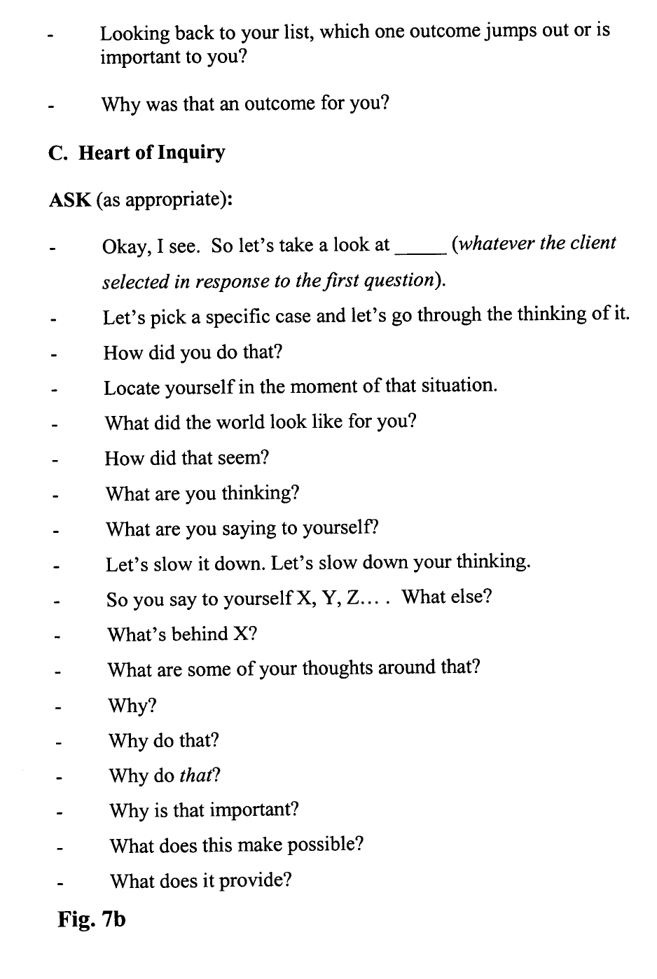

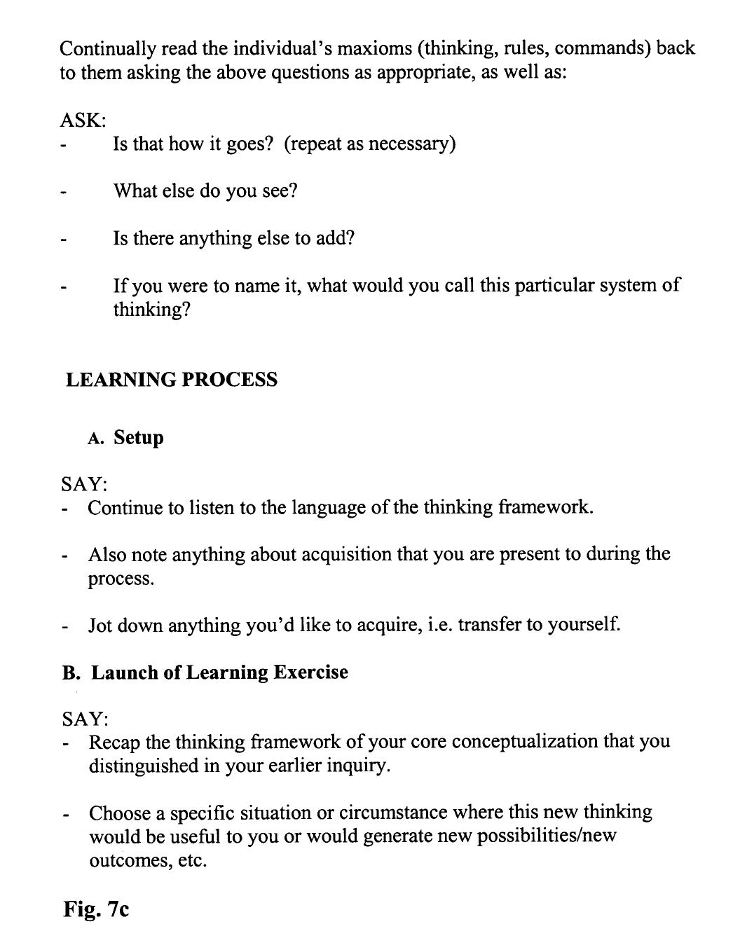

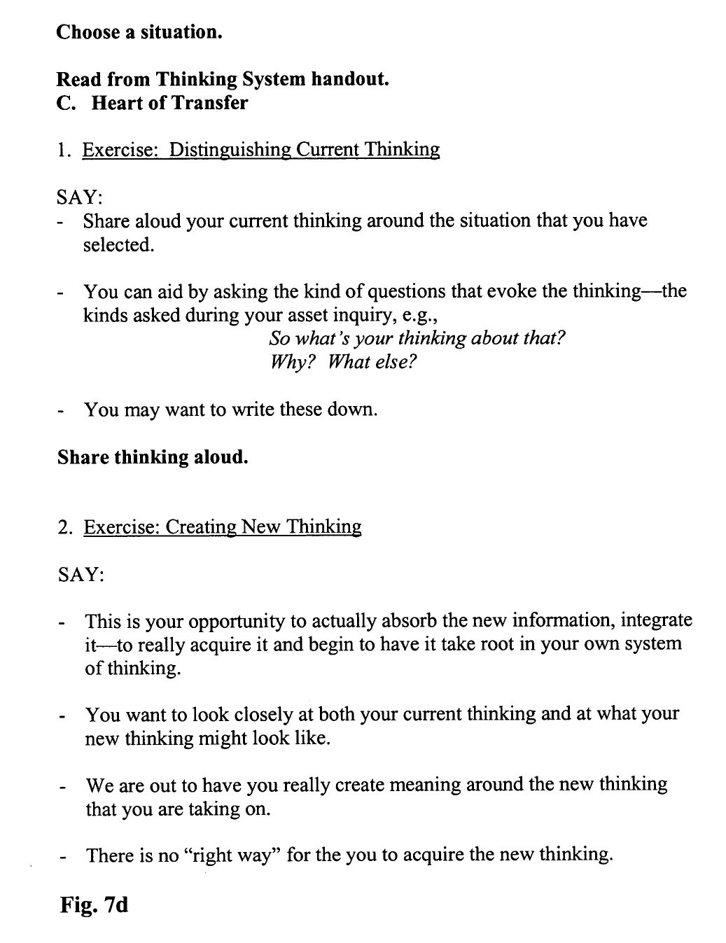

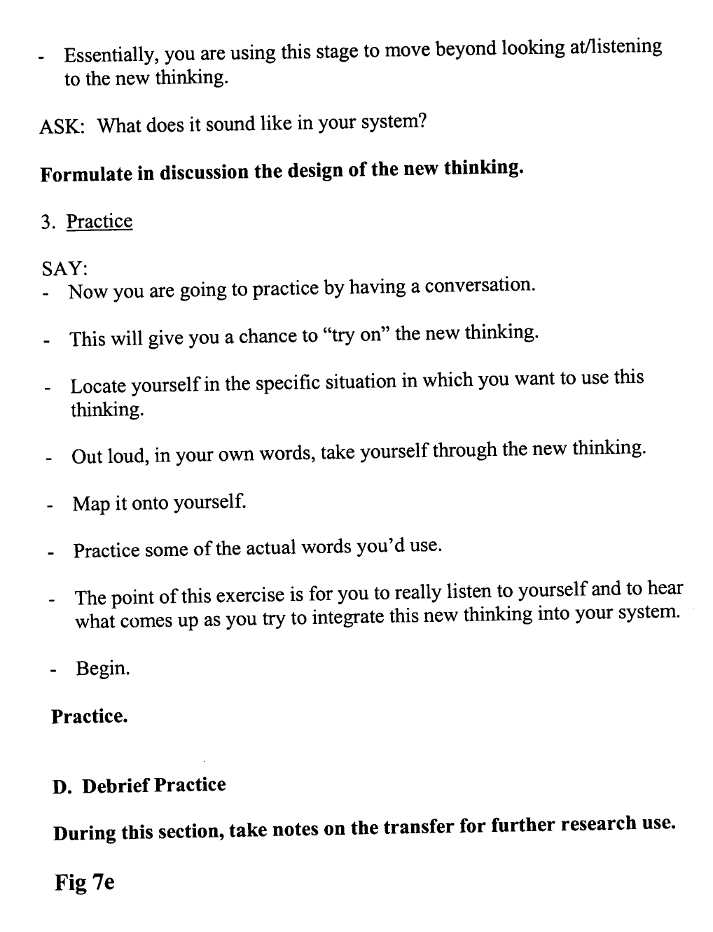

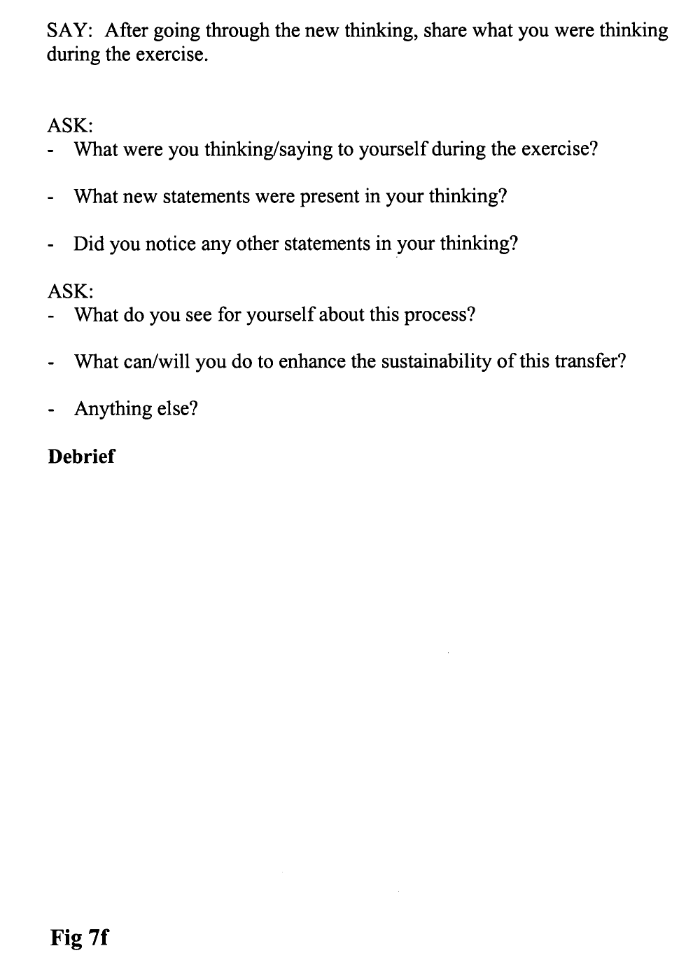

A specific implementation of the method disclosed is presented in FIGS. 7a through 7e. A protocol flow utilized in practicing the preferred embodiment is fully presented. FIG. 7 illustrates an inquiry process, whereby there is first a setup of the method where a presenter utilizing the method will present information to a participant to provide a background framework and informational setup as disclosed. Thereafter, the inquiry is launched to record outcome notes in keeping with the method of the invention. Specific inquiry protocols are presented in the figure. The next element of the process is getting to the heart of inquiry, as shown in Section C. Various queries are presented, which constitute the preferred embodiment in the method when practiced. The interplay between individuals maxioms is demonstrated in the example. Then the learning process begins as demonstrated by a presentation setup, and thereafter a launch of a learning exercise which invites an individual to review the framework of their core conceptualization distinguished in an earlier inquiry as above. At this point in the process, the individual would choose a specific situation or circumstance where the new thinking could be useful to that individual, or would generate new possibilities or new outcomes in the process. In choosing a situation, exercises then are presented, which present the heart of the transfer to identify current thinking associated with such outcomes, and thereafter to be in a position to move forward to create new thinking in an exercise. Specific examples of an exercise in creating new thinking is presented in FIG. 7. Continuing with the method, a discussion then ensues to formulate the design of the new thinking, and thereafter to engage in practice to reinforce the new thinking.

It is also helpful to have a debrief practice session in carrying out the methods and process disclosed in the present invention. For example, and as shown in FIG. 7 during a debriefing practice, the presentation using the method examines the thinking process about thinking itself. Specifically, going through the new thinking process that has generated by using the method, participants in the method share what they were thinking during the exercise itself.

It has been found that, as a result of this process, individuals are able to meta-cognate (think about their thinking), offering them the opportunity for infinite and recursive expansion of their own learning. Furthermore, they are able to generate a uniquely explicit level of comprehension, thereby exponentially expanding the efficiency, competency, and capacity with which they learn. Finally, individuals are able to apply this learning in a highly generalized yet extremely precise manner, allowing them to sustainably impact the quantity and quality of the outcomes they are capable of producing. Applications of the invention are anticipated in training and development, knowledge management, succession planning, education, counseling/therapy, coaching, self-improvement, and other settings.

Although the invention has been described in terms of the preferred embodiment and with particular examples that are used to illustrate carrying out the principals of the invention, it would be appreciated by those skilled in the art that other variations or adaptations of the principal disclosed herein, could be adopted using the same ideas taught herewith. It will be apparent to those practicing in the arts presented herein that other applications and related principals would benefit from the protocols and teachings presently presented. Such applications and principals are considered to be within the scope and spirit of the invention disclosed and as otherwise described in the appended claims.

What is claimed:

1. A process which teaches individuals to meta-cognate comprising the steps of:
having individuals create a list to distinguish their outcomes associated with a particular subject;
having individuals select a theme or specific outcome from said list and examine their thinking or relevant knowledge via language;
creating a visual model/schema of individuals thinking as expressed in their language;
teaching the individual to study their thinking in order to generate new thinking or learning via expansion of or addition to the present system; and
engaging the individual in learning via application of their current language or thinking system to new or additional content.

2. A process which teaches individuals to meta-cognate comprising the steps of:
having individuals distinguish their outcomes associated with a particular subject;
having individuals select a theme or specific outcome from that list and examine their thinking (relevant knowledge) via language;
creating a visual model/schema of their thinking as expressed in their language;
teaching the individual to study their thinking in order to generate new thinking (learning) via expansion of or addition to the present system; and
engaging the individual in learning via the acquisition of new thinking via the language of an outside source.

3. A process which teaches individuals to meta-cognate comprising the steps of:
having individuals distinguish their outcomes associated with a particular subject;
having individuals select a theme or specific outcome from that list and examine their thinking (relevant knowledge) via language;
creating a visual model/schema of their thinking as expressed in their language;
teaching the individual to study their thinking in order to generate new thinking (learning) via expansion of or addition to the present system;
engage the individual in learning via application of their current language or thinking system to new or additional content; and
engaging the individual in facilitating the learning of another by sharing the source code of their learning as represented in their language or thinking system.

4. A process of claim 1 further including the step of:
engaging the individual in learning via the acquisition of new thinking via the language of an outside source.

5. The process of claim 1 further including the step of:
engaging the individual in facilitating the learning of another by sharing the source code of their learning as represented in their language or thinking system.

6. The process of claim 1 further including the steps of:
engaging the individual in learning via the acquisition of new thinking via the language of an outside source; and
engaging the individual in facilitating the learning of another by sharing the source code of their learning as represented in their language or thinking system.
